(19) United States
(12) Patent Application Publication
(10) Pub. No.: US 2023/0079201 A1
(43) Pub. Date: Mar. 16, 2023

(54) SHOE CLEANING SYSTEM

(71) Applicant: Justin Shock, Nokomis, FL (US)

(72) Inventor: Justin Shock, Nokomis, FL (US)

(21) Appl. No.: 17/942,237

(22) Filed: Sep. 12, 2022

Related U.S. Application Data
(60) Provisional application No. 63/243,401, filed on Sep. 13, 2021.

(51) Int. Cl. A47L 23/04; A46B 9/02

(52) U.S. Cl. CPC A47L 23/04; A46B 9/02; A46B 2200/306

(57) ABSTRACT

In one or more arrangements, a shoe cleaning system is provided. The system includes a main body. In one or more arrangements, the main body is formed of an upper surface, lower surface, opposing sidewalls, opposing end walls, and a plurality of brushes. In one or more arrangements, the plurality of brushes extend out of the upper surface of the main body. In one or more arrangements, a plurality of reliefs are positioned in the lower surface of the main body. In one or more arrangements, a first opening extends through at least a portion of the main body. In one or more arrangements, the first opening facilitates attachment of the main body to a vehicle.

### CROSS-REFERENCE TO RELATED APPLICATIONS

The present application claims priority to U.S. Provisional Application 63/243,401 titled SHOE CLEANING SYSTEM filed on Sep. 13, 2021, the entirety of which is hereby incorporated by reference herein, including any figures, tables, drawings, and other information.

### FIELD OF THE DISCLOSURE

This disclosure relates to a device for cleaning debris from shoes. The device attaches to trucks, and other vehicles and equipment. More specifically and without limitation, this disclosure relates to a shoe cleaning system formed of a device with a plurality of brushes.

### OVERVIEW OF THE DISCLOSURE

Devices for cleaning shoes are well known in the art and are frequently used to prevent dirt and debris from entering buildings, homes, vehicles, and the like. There are countless types, forms and designs of shoe cleaning systems known in the art. Generally speaking, these devices supply tough bristles, brushes, or fibers for users to manually wipe their feet which will help to remove any debris clinging to shoes.

Shoe cleaning devices are typically placed in areas where users with unclean shoes travel. Many devices currently used may be placed in different areas and are moveable. The result is that the device may be unavailable when a user wants to clean their shoes, creating a problem for the user who wants to clean their shoes. Further when a user does locate a shoe cleaning device, it may be unsecured. When the user begins to clean their shoes, the device may move and prevent the user from effectively cleaning their shoes.

A number of different designs have been used to create a shoe cleaning system. These devices must be able to effectively displace any debris, mud, dust, dirt, rubble or clay that may be attached to a user's shoes. One such design is flat and rigid. While this design provides a stiff surface for a user to scrub their shoes against, the stiffness of the design does not allow it to conform to various surfaces which limits the locations it can be placed. Additionally, previous designs may not include attachment means for securing to surfaces, which may cause the system to move when a user applies pressure to clean their shoes. This would result in an ineffective cleaning process.

Therefore, for all the reasons stated above, and the reasons stated below, there is a need in the art for an improved shoe cleaning system which has the necessary strength, flexibility, and immovability to provide a stable cleaning surface, while also remaining easy to transport and secure to various locations.

Thus, it is a primary object of the disclosure to provide a shoe cleaning system that improves upon the state of the art.

Another object of the disclosure is to provide a shoe cleaning system that is formed of a main body.

Yet another object of the disclosure is to provide a shoe cleaning system that is flexible to conform to various surfaces.

Another object of the disclosure is to provide a shoe cleaning system that can be attached to various surfaces.

Yet another object of the disclosure is to provide a shoe cleaning system that may be attached to various surfaces using various mechanisms.

Another object of the disclosure is to provide a shoe cleaning system that is rigid.

Yet another object of the disclosure is to provide a shoe cleaning system that minimizes displacement when a user applies pressure.

Another object of the disclosure is to provide a shoe cleaning system that is relatively easy to manufacture.

Yet another object of the disclosure is to provide a shoe cleaning system that is easy to use.

Another object of the disclosure is to provide a shoe cleaning system that is relatively lightweight.

Yet another object of the disclosure is to provide a shoe cleaning system that is easy to move.

Another object of the disclosure is to provide a shoe cleaning system that has a robust design.

Yet another object of the disclosure is to provide a shoe cleaning system that is durable.

Another object of the disclosure is to provide a shoe cleaning system that has a long useful life.

Yet another object of the disclosure is to provide a shoe cleaning system that is not easily susceptible to wear and tear.

Another object of the disclosure is to provide a shoe cleaning system that is high quality.

Yet another object of the disclosure is to provide a shoe cleaning system that is relatively inexpensive.

Another object of the disclosure is to provide a shoe cleaning system that is easy to transport.

Yet another object of the disclosure is to provide a shoe cleaning system that protects shoe surfaces from damage caused by cleaning.

These and other objects, features, or advantages of the disclosure will become apparent from the specification, figures, and claims.

### BRIEF DESCRIPTION OF THE DRAWINGS

FIG. 1 is a perspective view of the shoe cleaning system in accordance with one or more arrangements, the view showing the shoe cleaning system having a main body with reliefs in the lower surface of the main body, openings in the sidewalls of the main body, and surface features in the form of cross-hatching in the upper surface of the main body; the view also showing the shoe cleaning system having a plurality of brushes with a plurality of bristles.

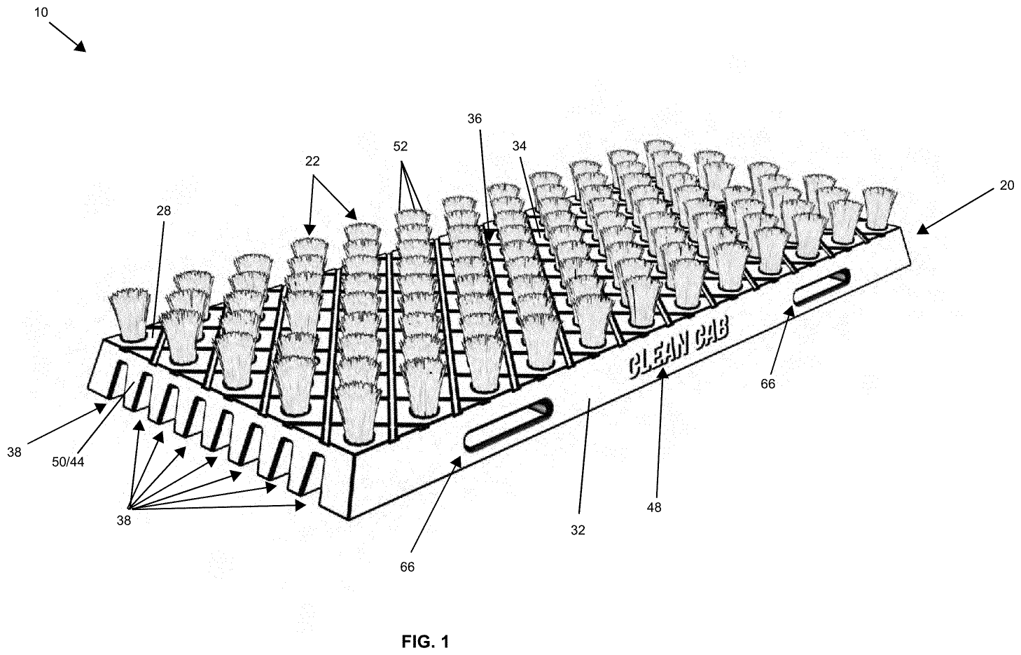

FIG. 2 is a bottom perspective view of the shoe cleaning system in accordance with one or more arrangements, the view showing the shoe cleaning system having a main body with reliefs in the lower surface of the main body and openings in the sidewalls of the main body; the view also showing the shoe cleaning system having a plurality of brushes with a plurality of bristles.

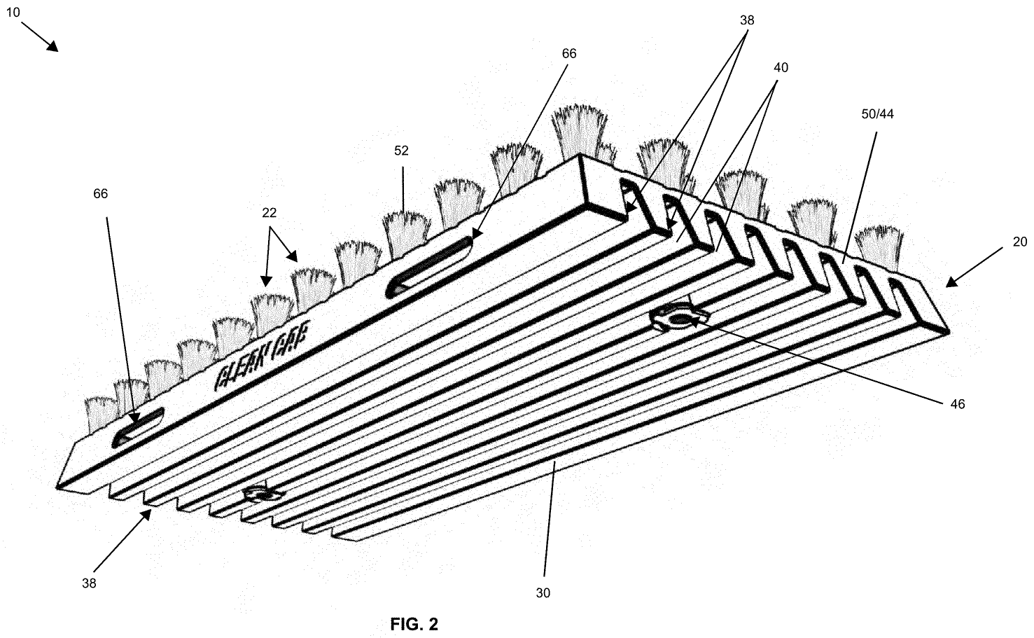

FIG. 3 is a side perspective view of the shoe cleaning system in accordance with one or more arrangements, the view showing the shoe cleaning system having a main body with openings in the sidewalls of the main body and surface features in the form of cross-hatching in the upper surface of the main body; the view also showing the shoe cleaning system having a plurality of brushes with a plurality of bristles.

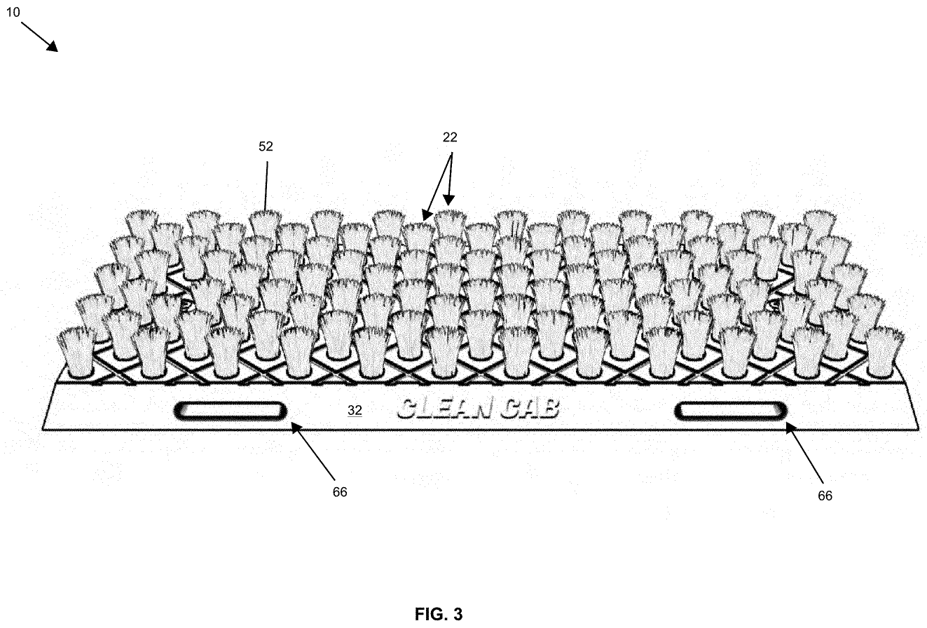

FIG. 4 is a perspective view of the shoe cleaning system in accordance with one or more arrangements, the view showing the shoe cleaning system having a main body with reliefs in the lower surface of the main body, openings in the sidewalls of the main body, and surface features in the form of cross-hatching in the upper surface of the main body; the view also showing the shoe cleaning system having a plurality of brushes with a plurality of bristles.

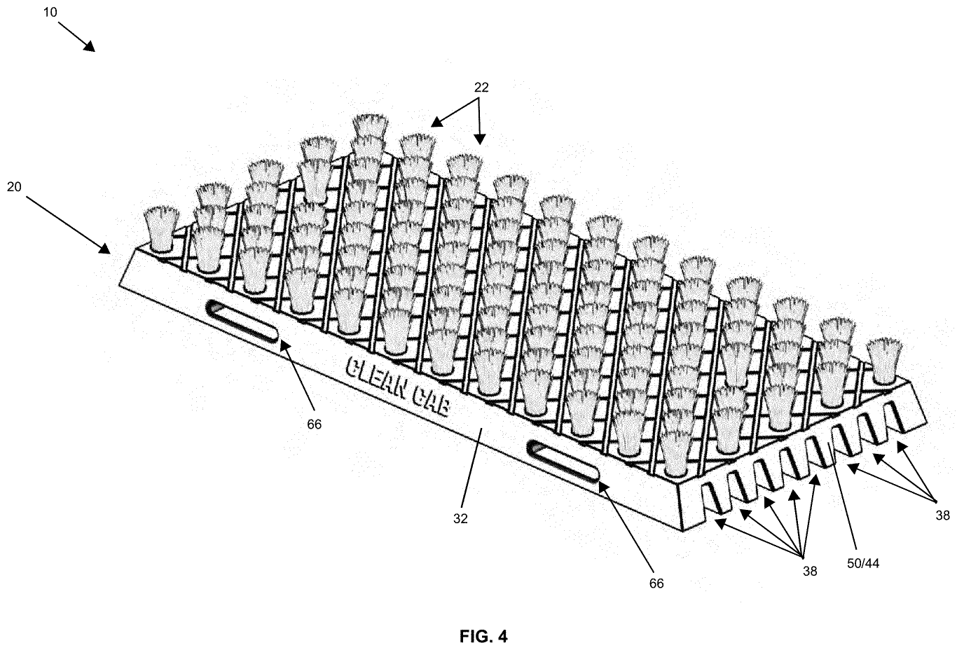

FIG. 5 is an end elevation view of the shoe cleaning system in accordance with one or more arrangements, the view showing the shoe cleaning system having a main body with reliefs in the lower surface of the main body, the reliefs each having an upper wall, side walls, and ends; the view also showing the shoe cleaning system having a plurality of brushes with a plurality of bristles.

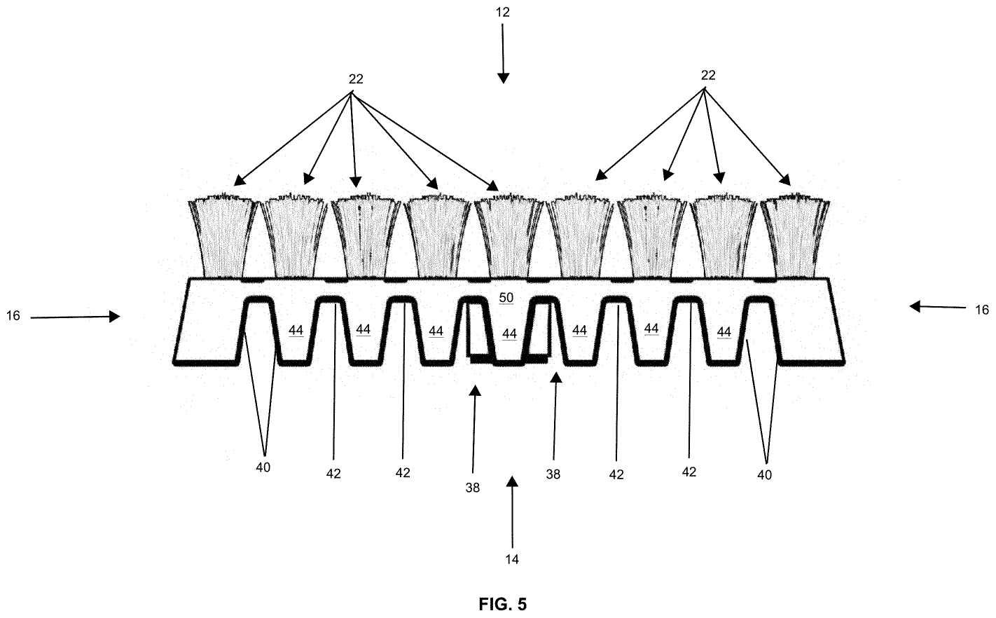

FIG. 6 is a side elevation view of the shoe cleaning system in accordance with one or more arrangements, the view showing the shoe cleaning system having a main body with openings in the sidewalls of the main body; the view also showing the shoe cleaning system having a plurality of brushes with a plurality of bristles.

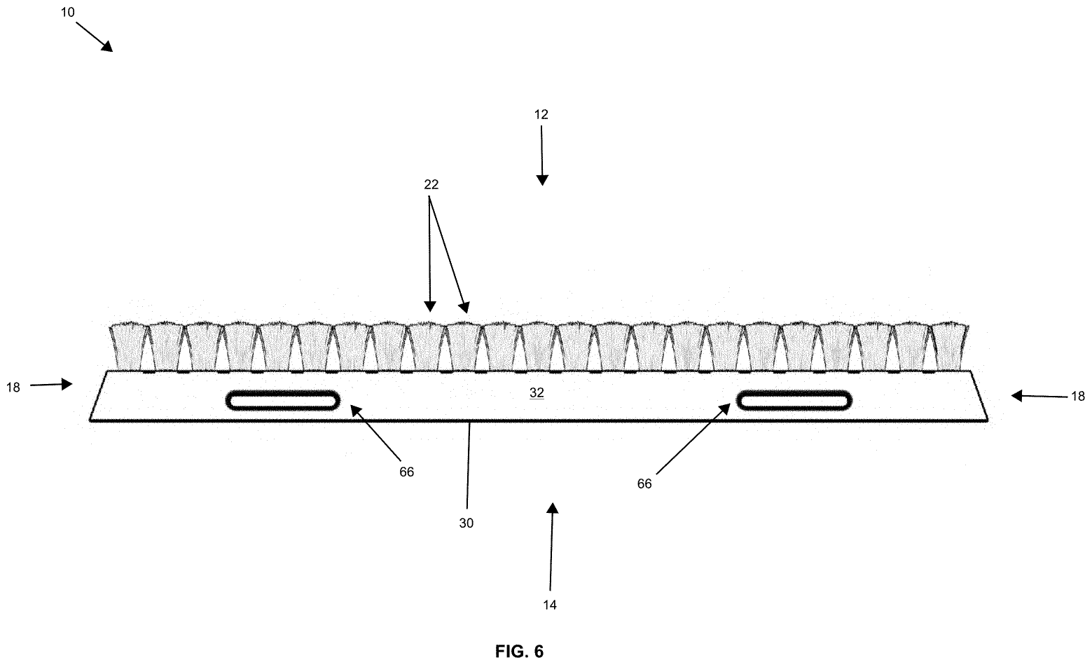

FIG. 7 is a top elevation view of the shoe cleaning system in accordance with one or more arrangements, the view showing the shoe cleaning system having a main body with surface features in the form of cross-hatching in the upper surface of the main body; the view also showing the shoe cleaning system having a plurality of brushes with a plurality of bristles.

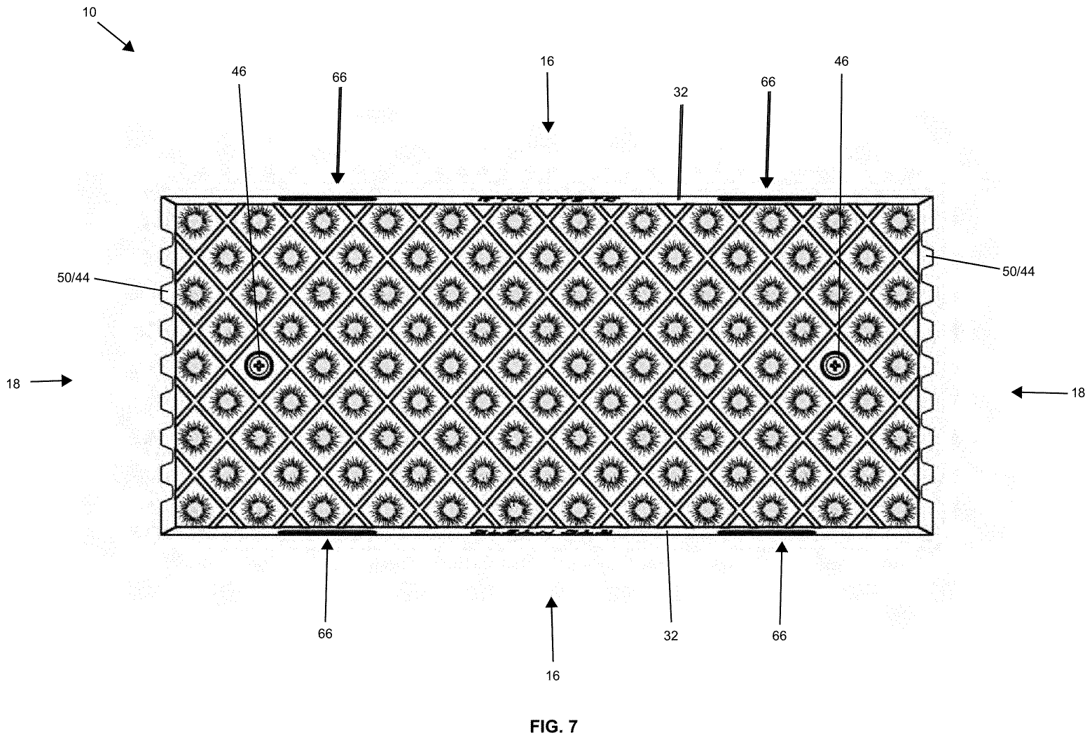

FIG. 8 is a top elevation view of the shoe cleaning system in accordance with one or more arrangements, the view showing the shoe cleaning system having a main body with surface features in the form of cross-hatching in the upper surface of the main body; the view also showing the shoe cleaning system having a plurality of brushes with a plurality of bristles; the view also showing the shoe cleaning system having an attachment member in the form of a bracket affixed to the upper surface of the main body

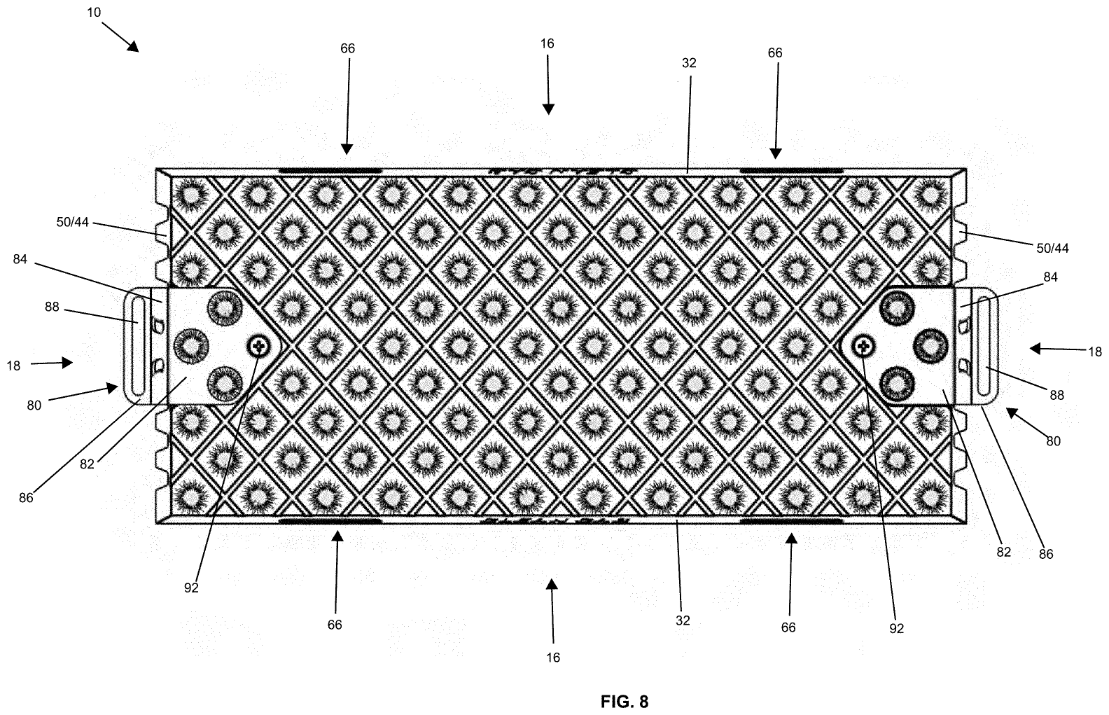

FIG. 9 is a perspective view of the shoe cleaning system in accordance with one or more arrangements, the view showing the shoe cleaning system having a main body with reliefs in the lower surface of the main body, openings in the sidewalls of the main body, and surface features in the form of cross-hatching in the upper surface of the main body; the view also showing the shoe cleaning system having a plurality of brushes with a plurality of bristles; the view also showing the shoe cleaning system having an attachment member in the form of a bracket affixed to the upper surface of the main body

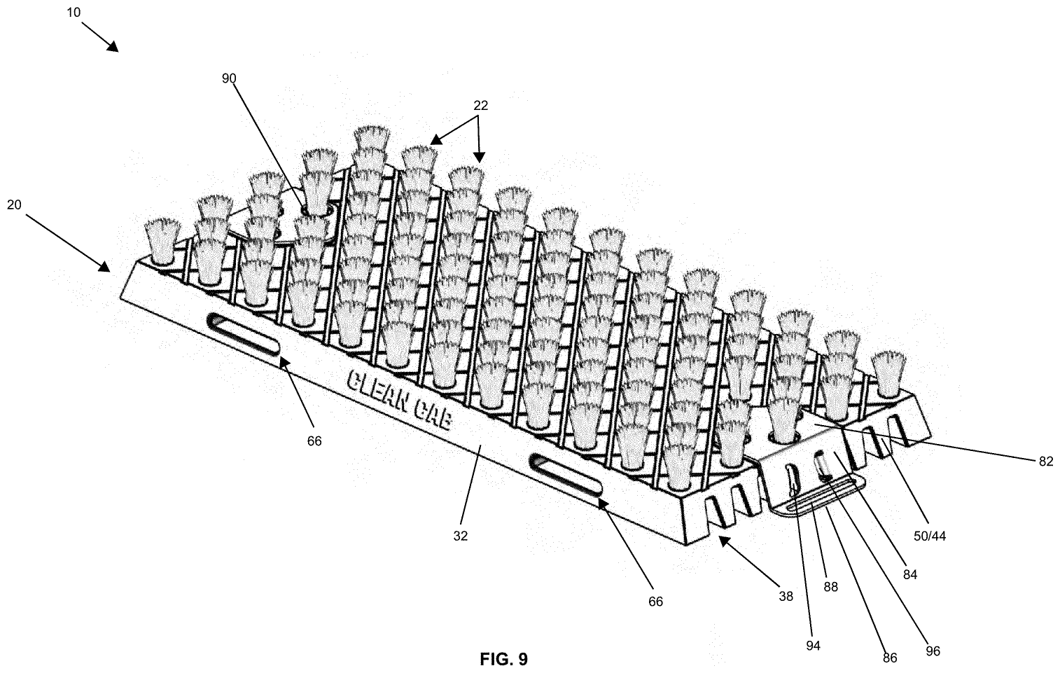

FIG. 10 is a perspective view of the shoe cleaning system in accordance with one or more arrangements, the view showing the shoe cleaning system having a main body with reliefs in the lower surface of the main body, openings in the sidewalls of the main body, and surface features in the form of cross-hatching in the upper surface of the main body; the view also showing the shoe cleaning system having a plurality of brushes with a plurality of bristles; the view also showing the shoe cleaning system having an attachment member in the form of a bracket affixed to the upper surface of the main body

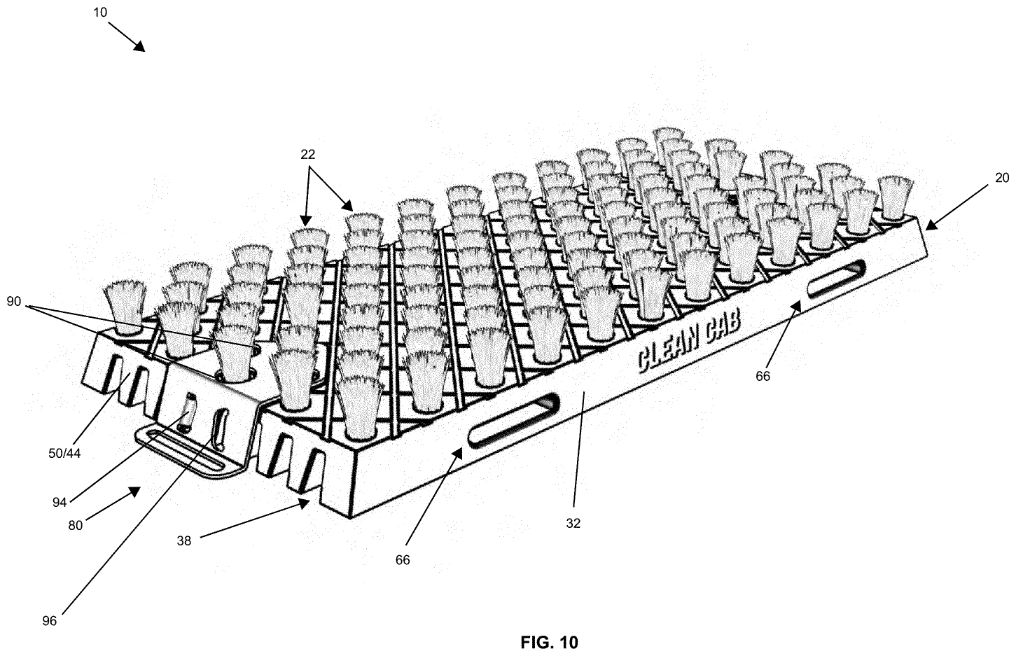

FIG. 11 is a perspective view of the shoe cleaning system in accordance with one or more arrangements, the view showing the shoe cleaning system having a main body with reliefs in the lower surface of the main body, openings in the sidewalls of the main body, and surface features in the form of cross-hatching in the upper surface of the main body; the view also showing the shoe cleaning system having a plurality of brushes with a plurality of bristles; the view also showing the shoe cleaning system having an attachment member in the form of a connection assembly with one or more tethers extending through at least a portion of the openings in the sidewalls of the main body, with the connection assembly fastening below the lower surface of the main body using a hook and loop fastener.

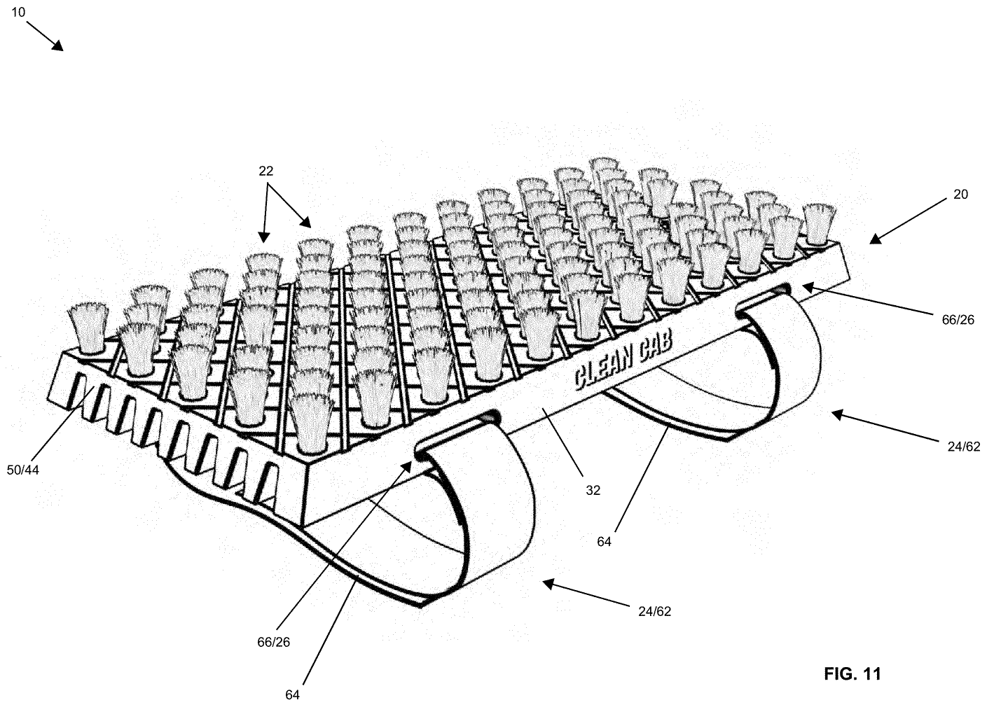

FIG. 12 is a perspective view of the shoe cleaning system in accordance with one or more arrangements, the view showing the shoe cleaning system having a main body with reliefs in the lower surface of the main body, openings in the sidewalls of the main body, and surface features in the form of cross-hatching in the upper surface of the main body; the view also showing the shoe cleaning system having a plurality of brushes with a plurality of bristles; the view also showing the shoe cleaning system having an attachment member in the form of a connection assembly with one or more tethers extending through at least a portion of the openings in the sidewalls of the main body, with the connection assembly fastening below the lower surface of the main body using a hook and loop fastener.

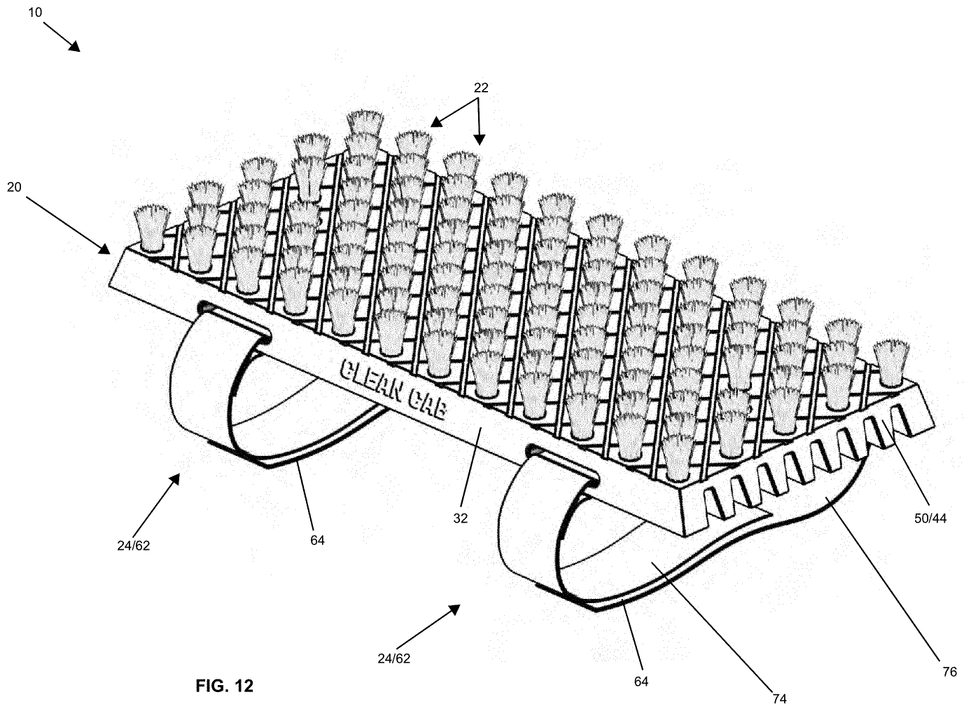

FIG. 13 is a top elevation view of the shoe cleaning system in accordance with one or more arrangements, the view showing the shoe cleaning system having a main body with surface features in the form of cross-hatching in the upper surface of the main body; the view also showing the shoe cleaning system having a plurality of brushes with a plurality of bristles; the view also showing the shoe cleaning system having an attachment member in the form of a strap extending through at least a portion of the openings in the sidewalls of the main body.

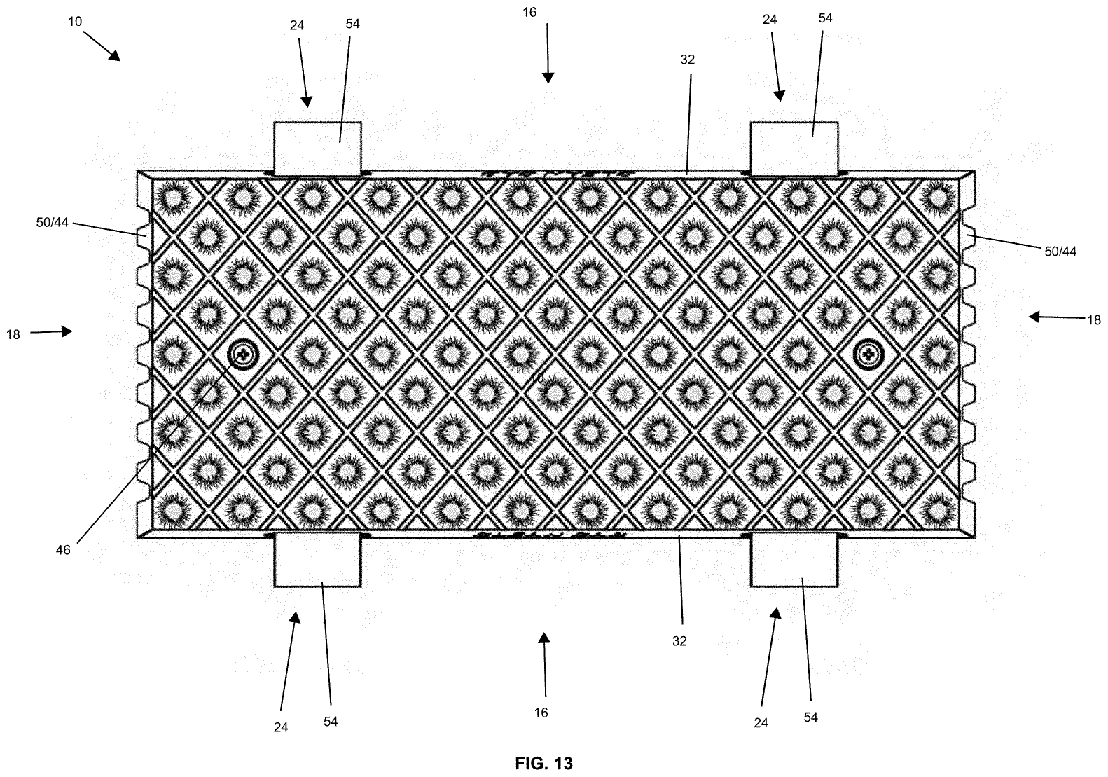

FIG. 14 is a bottom perspective view of the shoe cleaning system in accordance with one or more arrangements, the view showing the shoe cleaning system having a main body with reliefs in the lower surface of the main body and openings in the sidewalls of the main body; the view also showing the shoe cleaning system having a plurality of brushes with a plurality of bristles; the view also showing the shoe cleaning system having an attachment member in the form of a connection assembly with one or more tethers extending through at least a portion of the openings in the sidewalls of the main body, with the connection assembly fastening below the lower surface of the main body using a hook and loop fastener.

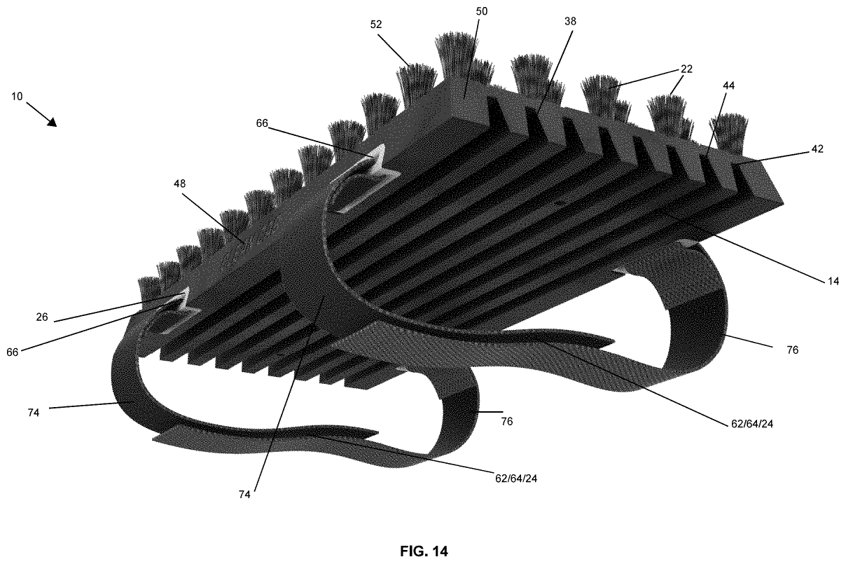

FIG. 15 is an end elevation view of the shoe cleaning system in accordance with one or more arrangements, the view showing the shoe cleaning system having a main body with reliefs in the lower surface of the main body, the reliefs each having an upper wall, side walls, and ends; the view also showing the shoe cleaning system having a plurality of brushes with a plurality of bristles; the view also showing the shoe cleaning system having an attachment member in the form of a connection assembly with one or more tethers extending through at least a portion of the openings in the sidewalls of the main body, with the connection assembly fastening below the lower surface of the main body using a hook and loop fastener.

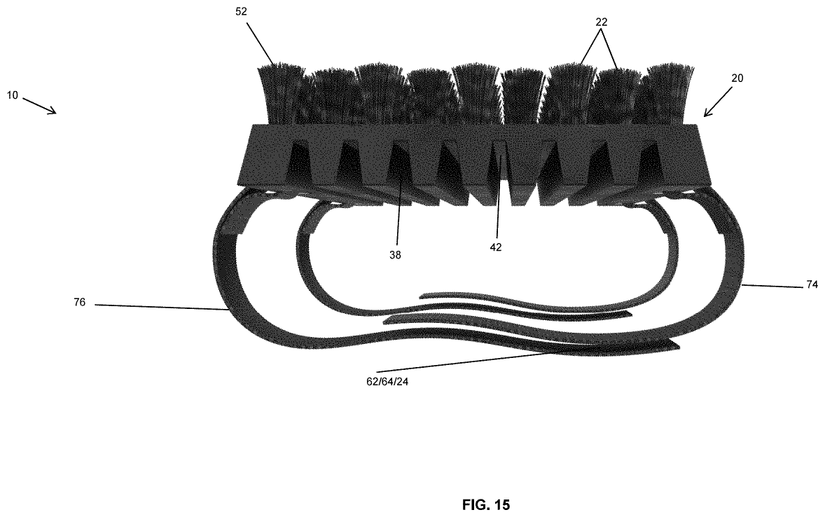

FIG. 16 is a side perspective view of the shoe cleaning system in accordance with one or more arrangements, the view showing the shoe cleaning system having a main body with openings in the sidewalls of the main body, and surface features in the form of cross-hatching in the upper surface of the main body; the view also showing the shoe cleaning system having a plurality of brushes with a plurality of bristles; the view also showing an attachment member in the form of a strap extending through at least a portion of the openings in the sidewalls of the main body, with the strap having a buckle for securing the strap.

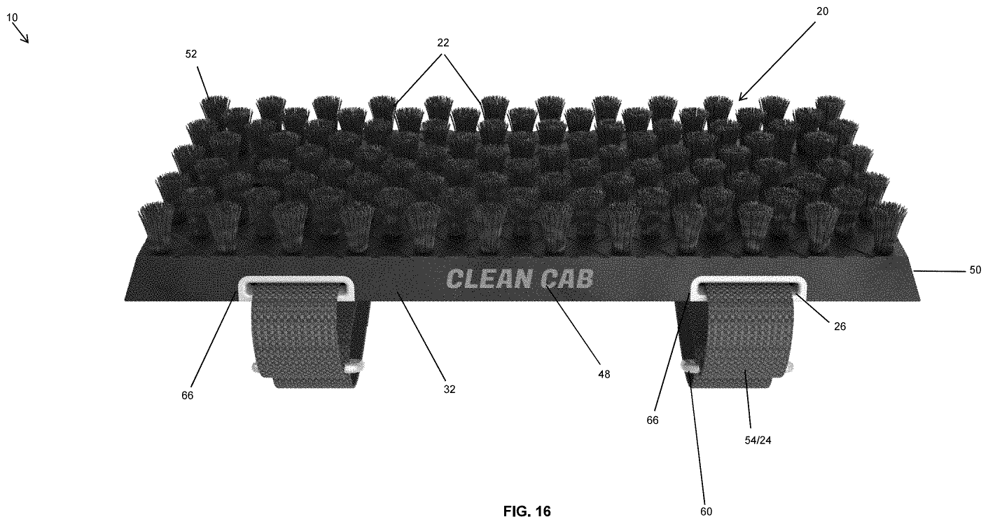

FIG. 17 is a perspective view of the shoe cleaning system in accordance with one or more arrangements, the view showing the shoe cleaning system having a main body with reliefs in the lower surface of the main body, openings in the sidewalls of the main body, and surface features in the form of cross-hatching in the upper surface of the main body; the view also showing the shoe cleaning system having a plurality of brushes with a plurality of bristles; the view also showing the shoe cleaning system having an attachment member in the form of a strap extending through at least a portion of the openings in the sidewalls of the main body, with the strap having a buckle for securing the strap.

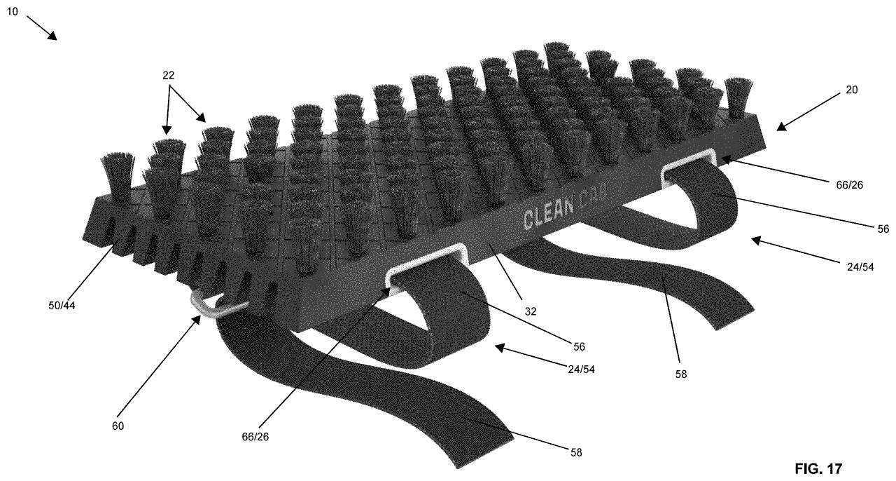

FIG. 18 is a bottom perspective view of the shoe cleaning system in accordance with one or more arrangements, the view showing the shoe cleaning system having a main body with reliefs in the lower surface of the main body and openings in the sidewalls of the main body; the view also showing the shoe cleaning system having a plurality of brushes with a plurality of bristles; the view also showing the shoe cleaning system having an attachment member in the form of a strap extending through at least a portion of the openings in the sidewalls of the main body, with the strap having a buckle for securing the strap.

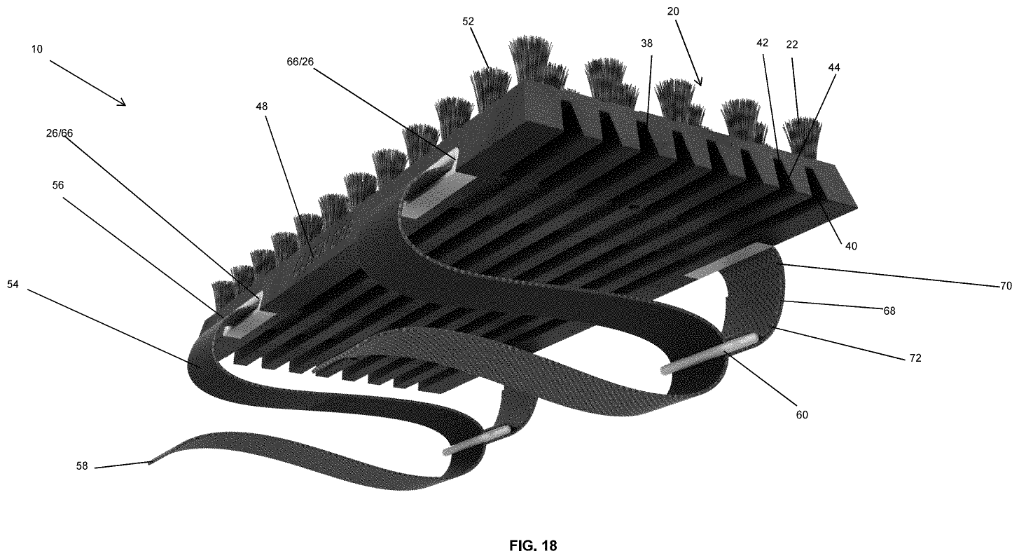

FIG. 19 is an end elevation view of the shoe cleaning system in accordance with one or more arrangements, the view showing the shoe cleaning system having a main body with reliefs in the lower surface of the main body, the reliefs each having an upper wall, side walls, and ends; the view also showing the shoe cleaning system having a plurality of brushes with a plurality of bristles; the view also showing the shoe cleaning system having an attachment member in the form of a strap extending through at least a portion of the openings in the sidewalls of the main body, with the strap having a buckle for securing the strap.

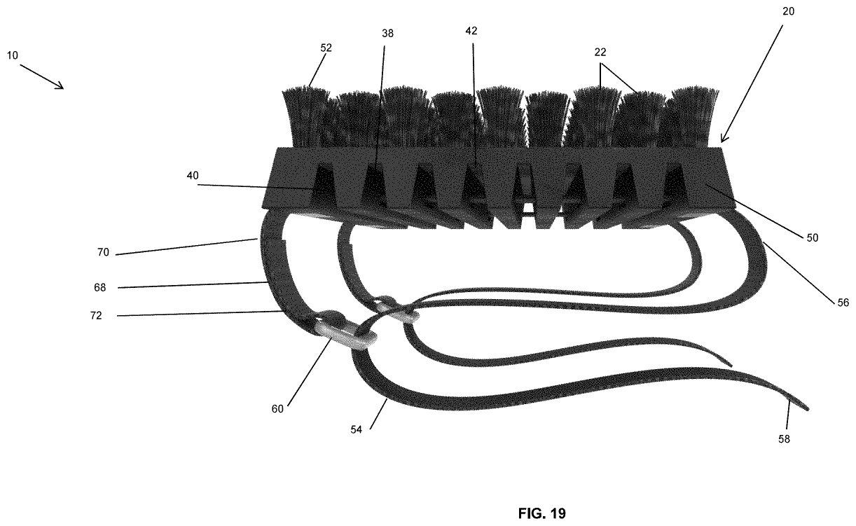

FIG. 20 is a perspective view of the shoe cleaning system in accordance with one or more arrangements, the view showing the shoe cleaning system having a main body, openings in the sidewalls of the main body, and surface features in the form of cross-hatching in the upper surface of the main body; the view also showing the shoe cleaning system having a plurality of brushes with a plurality of bristles; the view also showing the shoe cleaning system having an attachment member in the form of a bracket affixed to the upper surface of the main body.

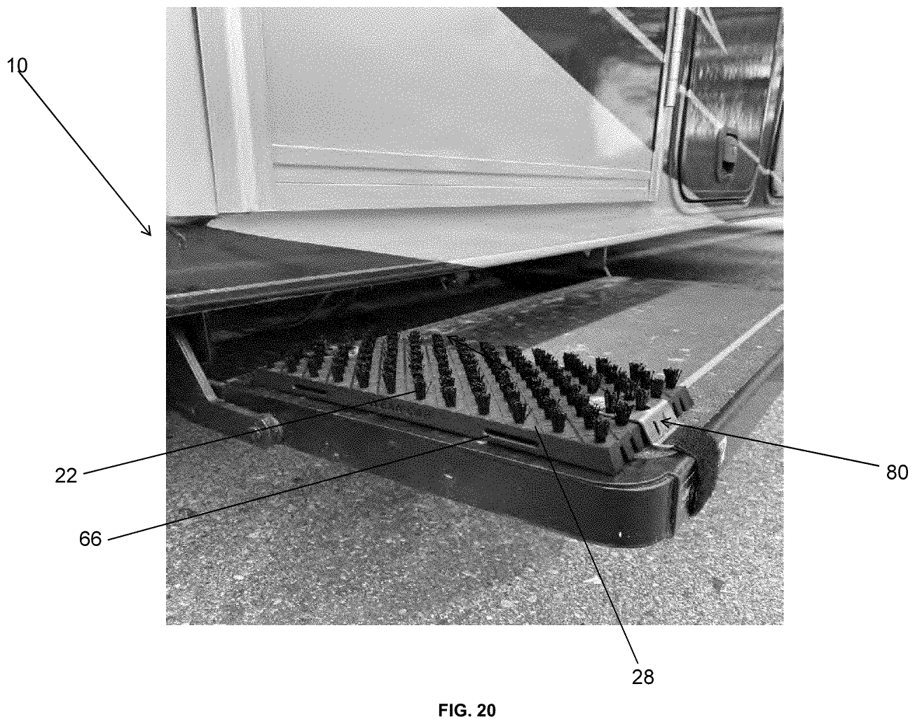

FIG. 21 is a perspective view of the shoe cleaning system in accordance with one or more arrangements, the view showing the shoe cleaning system having a main body with reliefs in the lower surface of the main body, openings in the sidewalls of the main body, and surface features in the form of cross-hatching in the upper surface of the main body; the view also showing the shoe cleaning system having a plurality of brushes with a plurality of bristles; the view also showing the shoe cleaning system having an attachment member in the form of a connection assembly with one or more tethers extending through at least a portion of the openings in the sidewalls of the main body, with the connection assembly fastening below the lower surface of the main body.

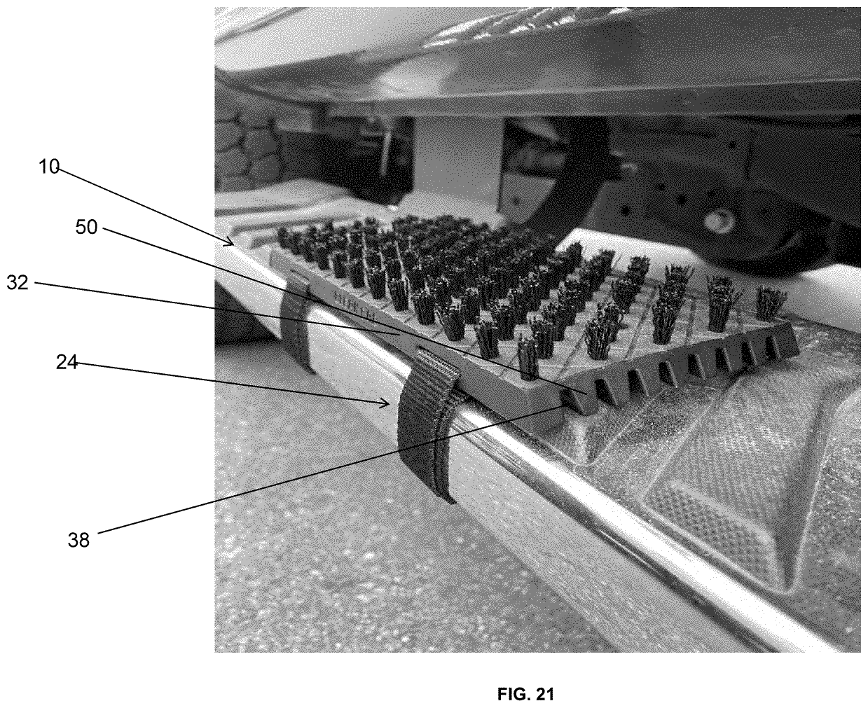

FIG. 22 is a side perspective view of the shoe cleaning system in accordance with one or more arrangements, the view showing the shoe cleaning system having a main body with openings in the sidewalls of the main body; the view also showing the shoe cleaning system having a plurality of brushes with a plurality of bristles; the view also showing an attachment member in the form of a connection assembly with one or more tethers extending through at least a portion of the openings in the sidewalls of the main body, with the connection assembly fastening below the lower surface of the main body.

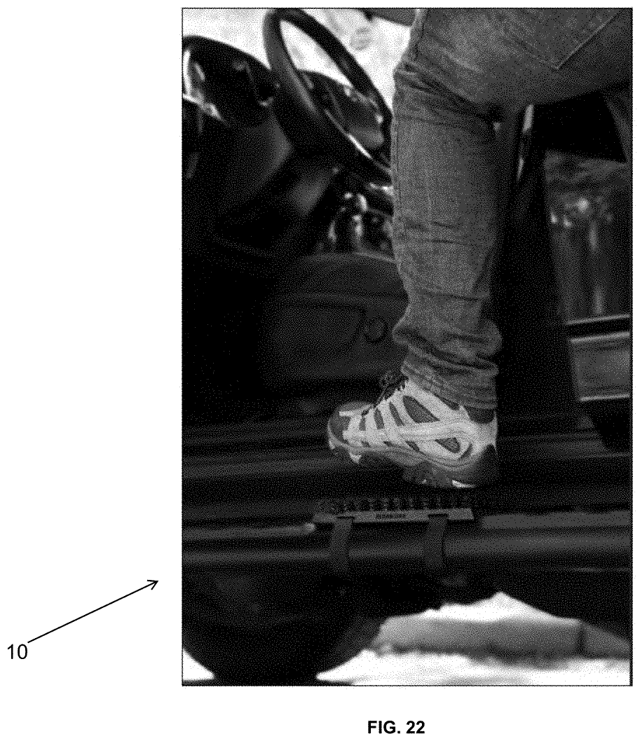

### SUMMARY OF THE DISCLOSURE

In one or more arrangements, a shoe cleaning system is provided. The system includes a main body. The main body is formed of an upper surface, lower surface, opposing sidewalls, opposing end walls, and a plurality of brushes. The plurality of brushes extend out of the upper surface of the main body. Additionally, a plurality of reliefs are positioned in the lower surface of the main body. Further, a first opening extends through at least a portion of the main body. The first opening facilitates attachment of the main body to a vehicle.

In one or more arrangements, the system includes a first attachment member. The first attachment member extends through at least a portion of the first opening. The first attachment member is configured and arranged to attach the main body to a vehicle.

In one or more arrangements, a second opening extends through at least a portion of the main body. The second opening facilitates attachment of the main body to a vehicle. Additionally, the system may include a second attachment member. The second attachment member extends through at least a portion of the second opening and is configured and arranged to attach the main body to a vehicle.

### DETAILED DESCRIPTION OF THE DISCLOSURE

In the following detailed description of the embodiments, reference is made to the accompanying drawings which form a part hereof, and in which is shown by way of illustration specific embodiments in which the invention may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures.

For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, the term “or” includes one or more of the associated listed items, such that “A or B” means “either A or B”. As used herein, the term “and” includes all combinations of one or more of the associated listed items, such that “A and B” means “A as well as B.” The use of “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually, or sequentially, to provide looping or other series of operations aside from single operations described below. It should be presumed that any embodiment or method having features and functionality described below, in any workable combination, falls within the scope of example embodiments.

Various disclosed embodiments may be primarily described in the context of shoe cleaning systems. However, the embodiments are not so limited. It is appreciated that the embodiments may be adapted for use in other applications, which may be improved by the disclosed structures, arrangements and/or methods. The system is merely shown and described as being used in the context of shoe cleaning systems for ease of description and as one of countless examples.

### Shoe Cleaning System 10:

With reference to the figures, a shoe cleaning system 10 (or simply “system 10”) is presented. System 10 is formed of any suitable size, shape, and design and is configured to allow users to clean their shoes. In the arrangement shown, as one example, system 10 includes a top side 12, bottom side 14, opposing sides 16, opposing ends 18, a main body 20, and a plurality of brushes 22.

### Main Body 20:

In the arrangement shown, as one example, system 10 includes a main body 20. Main body 20 is formed of any suitable size, shape, and design and is configured to provide a base to support a plurality of brushes 22. In the arrangement shown, as one example, main body 20 includes an upper surface 28, a lower surface 30, end walls 50, and sidewalls 32. Main body 20 is configured to contain a plurality of brushes 22 to allow a user to clean their shoes by system 10. In the arrangement shown, as one example, main body 20 has a generally square or rectangular shape.

However, any other size, shape, design or configuration is hereby contemplated for use.

### Upper Surface 28:

Upper surface 28 is formed of any suitable size, shape, and design and is configured to contain a plurality of brushes 22. In the arrangement shown, as one example, upper surface 28 has a generally square or rectangular planer shape which is generally flat extending between opposing sides 16 and opposing ends 18.

In this example arrangement, upper surface 28 has surface features 34. Surface features 34 are formed of any suitable size, shape, or design, and are configured to provide increased resistance between a user's shoe and upper surface 28 to facilitate removal of debris. In the arrangement shown, as one example, surface features 34 are shown as cross-hatching 36 or generally square or rectangular recesses that extend a distance downward into the upper surface 28. However, in an alternative arrangement, surface features 34 may be protrusions, a combination of protrusions and/or recesses, and/or any other configuration of features.

However, any other size, shape, design or configuration is hereby contemplated for use.

Further, in this example arrangement, upper surface 28 may have one or more openings 46. Openings 46 are formed of any suitable size, shape, or design, and are configured to facilitate attachment of system 10 to a vehicle. In the arrangement shown, as one example, openings 46 are shown as generally cylindrical, or circular recesses that extend through the main body 20 and lower surface 30. Although the arrangements are primarily described with reference to the upper surface 28 having openings 46, the embodiments are not so limited. Rather, it is contemplated that in various different arrangements, openings 46 may be positioned at any location that does not interfere with the positioning and interconnection of system 10 with various surfaces. Further, openings 46 may have various other shapes to accommodate diverse main bodies 20.

However, any other size, shape, design or configuration is hereby contemplated for use.

### Lower Surface 30:

In the arrangement shown, as one example, system 10 includes a lower surface 30. Lower surface 30 is formed of any suitable size, shape, and design and is configured to contain one or more reliefs 38. In the arrangement shown, as one example, lower surface 30 has a generally square or rectangular planer shape which is generally flat extending between opposing sides 16 and opposing ends 18.

In this example arrangement, lower surface 30 has reliefs 38. Reliefs 38 are formed of any suitable size, shape, or design, and are configured to allow the main body 20 to bend, flex, or conform to various surfaces on which the shoe cleaning system 10 may be placed. These surfaces may include but are not limited to; vehicle running boards or footboards, poles, benches, or the ground. In the arrangement shown, as one example, reliefs 38 are shown as generally square or rectangular recesses that extend a distance upward towards the upper surface 28. The lower surface 30 may have any number of reliefs 38. Each relief 38 may comprise opposing sidewalls 40 and one upper wall 42. The upper wall 42 being parallel to the upper surface 28 of the main body 20. In the arrangement shown, as one example, the reliefs 38 taper inward as they extend upward from the lower surface 30 of the main body 20. Further, the reliefs extend across the lower surface 30 of the main body 20 in parallel spaced relation to one another. Although the arrangements are primarily described with reference to lower surface 30 having reliefs 38, the embodiments are not so limited. Rather, it is contemplated that in various different arrangements, reliefs 38 may be positioned at any location that does not interfere with the positioning and interconnection of system 10 with various surfaces. Further, reliefs 38 may have various other shapes to accommodate diverse lower surfaces 30.

However, any other size, shape, design or configuration is hereby contemplated for use.

### Sidewalls 32:

In the arrangement shown, as one example, system 10 includes sidewalls 32. Sidewalls 32 are formed of any suitable size, shape, and design. In the arrangement shown, as one example, sidewalls 32 have a generally square or rectangular planer shape which is generally flat extending between opposing ends 18. Further, in the arrangement shown, as one example, the sidewalls 32 extend outward at an angle as they extend from the upper surface 28 to the lower surface 30.

However, any other size, shape, design or configuration is hereby contemplated for use.

In this example arrangement, sidewalls 32 have one or more logos 48. Logos 48 are formed of any suitable size, shape, or design, and may be at any location on the main body 20. In the arrangement shown, as one example, a logo 48 is shown in the center of a sidewall 32. Although the arrangements are primarily described with reference to sidewalls 32, the embodiments are not so limited. Rather, it is contemplated that in various different arrangements, logos 48 may be positioned at any location that does not interfere with the positioning and interconnection of system 10 with various surfaces. Further, logos 48 may have various other shapes to accommodate diverse shoe cleaning systems 10.

However, any other size, shape, design or configuration is hereby contemplated for use.

Further, in the arrangement shown, as one example, sidewalls 32 may include one or more openings 66. Openings 66 are formed of any suitable size, shape, or design, and are configured to facilitate attachment of system 10 to a vehicle. In the arrangement shown, as one example, openings 66 are shown as generally square, or rectangular recesses or openings that extend a distance towards the center of the main body 20. In an arrangement shown, as one example, openings 66 extend through the entirety of main body 20, extending between opposing sidewalls 32 thereby allowing for strap 54 and/or attachment member 24 to extend through main body 20. Additionally or alternatively, in an arrangement shown, openings 66 extend through only a portion of main body 20 and connect with one or more reliefs 38 in lower surface 30 thereby allowing for strap 54 and/or attachment member 24 to exit through relief 38 and/or out lower surface 30. Additionally or alternatively, in an arrangement shown, openings 66 extend through only a portion of main body 20 and exit through an opening in lower surface 30 thereby allowing for strap 54 and/or attachment member 24 out lower surface 30. Although the arrangements are primarily described with reference to the sidewalls 32 having openings 66, the embodiments are not so limited. Rather, it is contemplated that in various arrangements openings 66 may be positioned at any location that does not interfere with the positioning and interconnection of system 10 with various surfaces. Further, openings 66 may have various other shapes to accommodate diverse sidewalls 32.

However, any other size, shape, design or configuration is hereby contemplated for use.

Additionally, in the arrangement shown as one example, openings 66 may include one or more inserts 26. Inserts 26 are formed of any suitable size, shape, and design and are configured to provide a method to connect the shoe cleaning system 10 to various surfaces. In the arrangement shown, as one example, one or more inserts 26 are located within openings 66 and attach to one or more attachment members 24 which facilitate the attachment of system 10 to a surface. In this example arrangement, the inserts 26 are formed of a plastic material which may be harder than the material of the main body 20 thereby strengthening the connection between strap 54 of attachment member 24 and main body 20. However, inserts 26 may be formed of rubber material, synthetic rubber material, acrylic material, nylon material, polyethylene material, or any other composite material and/or non-metallic material. Additionally or alternatively, in one or more arrangements, inserts 26 are formed of metallic materials or a combination of metallic materials and non-metallic materials or components. In this example arrangement, inserts 26 are located within openings 66. However, the embodiments are not so limited. Rather, it is contemplated that in various different arrangements, one or more inserts 26 may be positioned at any location that does not interfere with the positioning and interconnection of system 10 with various surfaces. Moreover, it is further contemplated that in some arrangements, the inserts 26 may be omitted.

However, any other size, shape, design or configuration is hereby contemplated for use.

### End Walls 50:

In the arrangement shown, as one example, system 10 includes end walls 50. End walls 50 are formed of any suitable size, shape, and design. In the arrangement shown, as one example, end walls 50 have a generally square or rectangular planer shape which is generally flat extending between opposing sides 16. Further in the arrangement shown, in one example, the end walls 50 extend outward at an angle as they extend from the upper surface 28 to the lower surface 30.

However, any other size, shape, design or configuration is hereby contemplated for use.

In this example arrangement, end walls 50 have one or more ends 44 of reliefs 38. Although the example arrangement is primarily described with reference to end walls 50 having ends 44 of reliefs 38, the embodiments are not so limited. Rather, it is contemplated that ends 44 of reliefs 38 may have various other shapes to accommodate diverse end walls 50.

However, any other size, shape, design or configuration is hereby contemplated for use.

### Plurality of Brushes 22:

In the arrangement shown, as one example, system 10 includes a plurality of brushes 22. The plurality of brushes 22 are formed of any suitable size, shape, and design and are configured to comprise one or more groups of a plurality of bristles 52 arranged in a pattern across the surface of the main body 20. In the arrangement shown, as one example, the plurality of brushes 22 includes one or more groups of a plurality of bristles 52 that extend upwards and away from the upper surface 28 of the main body 20. However, the embodiments are not so limited. Rather, it is contemplated that a plurality of brushes 22 may have greater or fewer groups of a plurality of bristles 52 arranged in different shapes or positions.

However, any other size, shape, design or configuration is hereby contemplated for use.

### Plurality of Bristles 52:

In the arrangement shown, as one example, the plurality of brushes 22 includes a plurality of bristles 52. The plurality of bristles 52 are formed of any suitable size, shape, and design and are configured to connect to and extend away from upper surface 28 of the main body 20. In the arrangement shown, the plurality of bristles 52 has an elongated circular or cylindrical shape, however any other shape or configuration is hereby contemplated for use.

In this example arrangement, a plurality of bristles 52 are formed of an animal hair material, a plastic material, a rubber material, a synthetic rubber material, a nylon material, an acrylic material, a polyester material, a polyethylene material, or any other composite material and/or non-metallic material. Additionally, or alternatively, in one or more arrangements, the plurality of bristles 52 are formed of metallic materials or a combination of metallic and non-metallic materials or components.

In this example arrangement, each bristle in each plurality of bristles 52 may be formed of a single, unitary member that is formed in a manufacturing process such as molding, pressing, forming, additive formation, machining, extrusion, or the like to form a unitary and monolithic member. Alternatively, each bristle may be formed of multiple pieces that are connected or assembled to one another such as through fasteners, bonding, adhering, adhesives, interlocking, or any other connecting method or means. No matter what process is used to create each bristle, bristle rigidity allows a user to apply pressure along the plurality of brushes 22. The friction created removes any debris from the user's shoes.

In the arrangement shown, each bristle in a plurality of bristles 52 has a solid internal construction. However, the embodiments are not so limited. Rather, it is contemplated that in one or more arrangements, the plurality of bristles 52 may be of hollow internal construction, honeycomb internal construction, or any other internal construction.

However, any other size, shape, design or configuration is hereby contemplated for use.

### Attachment Member 24:

In the arrangement shown, as one example, system 10 may include one or more attachment members 24. An attachment member 24 is formed of any suitable size, shape, and design and is configured to provide a method to connect the shoe cleaning system 10 to various surfaces.

In the arrangement shown, as one example, one or more attachment members 24 connect to the main body 20 of a shoe cleaning system 10 through one or more openings 66 containing one or more inserts 26 in a sidewall 32 of the main body 20.

In the arrangement shown, as one example, attachment member 24 comprises various configurations to allow attachment of system 10 to a surface in a variety of ways. The various configurations of attachment member 24 allows system 10 to connect to a surface using the sidewalls 32 and/or the upper surface 28 of main body 20. Having various configurations of attachment member 24 allows system 10 to connect to a surface lengthwise using the sidewalls 32 of main body 20 and/or widthwise using the end walls 50 of main body 20.

In the arrangement shown, as one example, attachment member 24 may comprise one or more straps 54 having a first end 56 and a second end 58, one or more buckle straps 68, and one or more buckles 60. Additionally, or alternatively, in one or more arrangements, attachment member 24 may include one or more connection assemblies 62 having a first tether 74 and a second tether 76 fastened to each other using a hook and loop fastener 64. Additionally or alternatively, in one or more arrangements, attachment member 24 may include one or more brackets 80 having an upper portion 82, side portion 84, and lower portion 86. Additionally or alternatively, attachment member 24 may include any other attachment means. The attachment member 24 may facilitate connection between the shoe cleaning system 10 and various surfaces. These surfaces may include but are not limited to; vehicle running boards or footboards, poles, benches, or the ground.

However, any other size, shape, design or configuration is hereby contemplated for use.

### Strap 54:

In the arrangement shown, as one example, attachment member 24 may include one or more straps 54 to facilitate attachment of system 10 using the sidewalls 32 of main body 20. Strap 54 is used in connection with buckle strap 68 and buckle 60 to facilitate connection of system 10. Strap 54 is formed of any suitable size, shape, and design and is comprised of a first end 56 and a second end 58. In the arrangement shown, the first end 56 of strap 54 is attached to the main body 20 through an opening 66 containing an insert 26 located in a sidewall 32 of the main body 20. However, embodiments are not so limited. Rather, it is contemplated that strap 54 may be attached to the main body 20 using various different types of rigid or flexible connections including but not limited to inserts, knobs, holes, recesses, protrusions, glue, knots, nails, screws, and/or any other type of attachment means.

In the arrangement shown, the second end 58 of strap 54 is used in connection with buckle 60 to facilitate attachment of the system 10 to a surface.

In this example arrangement, strap 54 is formed of a nylon material, plastic material, rubber material, synthetic rubber material, acrylic material, polyethylene material, or any other composite material and/or non-metallic material. Additionally or alternatively, in one or more arrangements, the strap 54 is formed of metallic materials or a combination of metallic materials and non-metallic materials or components.

In this example arrangement, strap 54 is attached to the sidewall 32 of the main body 20. However, the embodiments are not so limited. Rather, it is contemplated that in various different arrangements, strap 54 may be positioned at any location that does not interfere with the positioning and interconnection of system 10 with various surfaces. Moreover, it is further contemplated that in some arrangements, strap 54 may be omitted.

However, any other size, shape, design or configuration is hereby contemplated for use.

### Buckle Strap 68:

In the arrangement shown, as one example, attachment member 24 may include one or more buckle straps 68. In the arrangement shown, as one example, buckle strap 68 is used in connection with strap 54 and buckle 60 to facilitate attachment of system 10 using the sidewalls 32 of main body 20. Buckle strap 68 is formed of any suitable size, shape, and design and is comprised of a first end 70 and a second end 72. In the arrangement shown, the first end 70 of buckle strap 68 is attached to the main body 20 through an opening 66 containing an insert 26 located in a sidewall 32 of the main body 20. However, embodiments are not so limited. Rather, it is contemplated that buckle strap 68 may be attached to the main body 20 using various different types of rigid or flexible connections including but not limited to inserts, knobs, holes, recesses, protrusions, glue, knots, screws, nails and/or any other type of attachment means.

In the arrangement shown, the second end 72 of buckle strap 68 is used in connection with buckle 60 to facilitate attachment of the system 10.

In this example arrangement, buckle strap 68 is formed of a nylon material, plastic material, rubber material, synthetic rubber material, acrylic material, polyethylene material, or any other composite material and/or non-metallic material. Additionally or alternatively, in one or more arrangements, buckle strap 68 is formed of metallic materials or a combination of metallic materials and non-metallic materials or components.

In this example arrangement, buckle strap 68 is attached to the main body 20 by an opening 66 containing an insert 26 located in a sidewall 32 of the main body 20. However, the embodiments are not so limited. Rather, it is contemplated that in various different arrangements, buckle strap 68 may be positioned at any location that does not interfere with the positioning and interconnection of system 10 with various surfaces. Moreover, it is further contemplated that in some arrangements, buckle strap 68 may be omitted.

However, any other size, shape, design or configuration is hereby contemplated for use.

### Buckle 60:

In the arrangement shown, as one example, attachment member 24 may include one or more buckles 60. In the arrangement shown, as one example, buckle 60 is used in connection with strap 54 and buckle strap 68 to facilitate attachment of system 10 using the sidewalls 32 of main body 20. Buckle 60 is formed of any suitable size, shape, and design. In the arrangement shown, the buckle 60 is attached to the second end 72 of buckle strap 68.

In this example arrangement, buckle 60 is formed of a plastic material, rubber material, synthetic rubber material, acrylic material, nylon material, polyethylene material, or any other composite material and/or non-metallic material. Additionally or alternatively, in one or more arrangements, the buckle 60 is formed of metallic materials or a combination of metallic materials and non-metallic materials or components.

In this example arrangement, buckle 60 is attached to the main body 20 by buckle strap 68. However, the embodiments are not so limited. Rather, it is contemplated that in various different arrangements, buckle 60 may be positioned at any location that does not interfere with the positioning and interconnection of system 10 with various surfaces. Moreover, it is further contemplated that in some arrangements, buckle 60 may be omitted.

However, any other size, shape, design or configuration is hereby contemplated for use.

### Connection Assembly 62:

In the arrangement shown, as one example, attachment member 24 may include one or more connection assemblies 62. In the arrangement shown, as one example, connection assembly 62 may include a first tether 74, a second tether 76, and one or more hook and loop fasteners 64 to facilitate attachment of system 10 using the sidewalls 32 of main body 20. Connection assembly 62 is formed of any suitable size, shape, and design.

In the arrangement shown, as one example, the first tether 74 and the second tether 76 of the connection assembly 62 are attached to the main body 20 at an insert 26 located in an opening 66 of a sidewall 32 of the main body 20. Further, it is contemplated that the first tether 74 and second tether 76 may be attached to the main body 20 using various different types of rigid or flexible connections including but not limited to inserts, knobs, holes, recesses, protrusions, glue, knots, screws, nails and/or any other type of attachment means.

In this example arrangement, the first tether 74 and the second tether 76 of the connection assembly 62 are formed of a nylon material, plastic material, rubber material, synthetic rubber material, acrylic material, polyethylene material, or any other composite material and/or non-metallic material. Additionally or alternatively, in one or more arrangements, the first tether 74 and the second tether 76 of the connection assembly 62 are formed of metallic materials or a combination of metallic materials and non-metallic materials or components.

In this example arrangement, the first tether 74 and the second tether 76 of connection assembly 62 are attached to the main body 20 by using inserts 26 in openings 66 in the sidewalls 32 of the main body 20. However, the embodiments are not so limited. Rather, it is contemplated that in various different arrangements, the first tether 74 and second tether 76 of connection assembly 62 may be positioned at any location that does not interfere with the positioning and interconnection of system 10 with various surfaces. Moreover, it is further contemplated that in some arrangements, connection assembly 62 may be omitted.

However, any other size, shape, design or configuration is hereby contemplated for use.

### Hook and Loop Fastener 64:

In the arrangement shown, as one example, attachment member 24 may include one or more hook and loop fasteners 64. In the arrangement shown, as one example, attachment member 24 includes a connection assembly 62 which includes one or more hook and loop fasteners 64 to facilitate simple attachment of system 10 along the sidewalls 32 of main body 20. The hook and loop fastener 64 is formed of any suitable size, shape, and design. In the arrangement shown, the hook and loop fastener 64 is located at the ends of the first tether 74 and second tether 76 that are not attached to the main body 20.

In this example arrangement, the hook and loop fastener 64 is formed of two materials, one with hooks and one with loops which connect to one another. Additionally or alternatively, in one or more arrangements, the hook and loop fastener 64 is formed of a combination of materials suitable for attachment.

In this example arrangement, the hook and loop fastener 64 is attached to the ends of the first tether 74 and the second tether 76 that are not attached to the main body 20. However, the embodiments are not so limited. Rather, it is contemplated that in various different arrangements, the hook and loop fastener 64 may be positioned at any location on the first tether 74 and second tether 76 that does not interfere with the positioning and interconnection of system 10 with various surfaces. Moreover, it is further contemplated that in some arrangements, the hook and loop fastener 64 may be omitted.

However, any other size, shape, design or configuration is hereby contemplated for use.

### Bracket 80:

In the arrangement shown, as one example, attachment member 24 may include one or more brackets 80. In the arrangement shown, as one example, the attachment member 24 includes a bracket 80 to facilitate attachment of system 10 along the end walls 50 of main body 20. Bracket 80 is formed of any suitable size, shape, and design and is comprised of an upper portion 82, side portion 84, and lower portion 86.

In this example arrangement, bracket 80 is formed of metallic materials or a combination of metallic materials and non-metallic materials or components. Additionally or alternatively, in one or more arrangements, bracket 80 may be formed of a nylon material, plastic material, rubber material, synthetic rubber material, acrylic material, polyethylene material, or any other composite material and/or non-metallic material.

In this example arrangement, bracket 80 is attached at the end wall 50 of the main body 20. However, the embodiments are not so limited. Rather, it is contemplated that in various different arrangements, bracket 80 may be positioned at any location on the main body 20 that does not interfere with the positioning and interconnection of system 10 with various surfaces. Moreover, it is further contemplated that in some arrangements, the bracket 80 may be omitted.

However, any other size, shape, design or configuration is hereby contemplated for use.

### Upper Portion 82

In the arrangement shown, as one example, bracket 80 includes an upper portion 82. Upper portion 82 is formed of any suitable size, shape, or design. In the arrangement shown, as one example, upper portion 82 is generally flat and extends across upper surface 28 of main body 20. Further, upper portion 82 generally extends in parallel spaced relation to upper surface 28. Upper portion 82 is comprised of one or more holes 90 and one or more openings 92.

In the arrangement shown, as one example, holes 90 in upper portion 82 may be of any size, shape, or design to accommodate the plurality of brushes 22 located on the upper surface 28 of main body 20. When bracket 80 is placed onto the upper surface 28 of system 10, the plurality of brushes 22 will extend through the holes 90 so that the upper portion 82 of the bracket 80 is pressed directly against upper surface 28 of system 10.

Further, in the arrangement shown, as one example, one or more openings 92 in upper portion 82 may be of any size, shape, or design to allow bracket 80 to be attached to the main body 20. Openings 92 allow bracket 80 to be attached to main body 20 using bolts, screws, nails, or any other attachment means which may be directed through the one or more openings 92.

In the arrangement shown, as one example, bracket 80 is attached to main body 20 when an attachment means extends through the one or more openings 92 in upper portion 82. However, embodiments are not so limited. Rather, it is contemplated that bracket 80 may be attached to main body 20 using various different types of rigid or flexible connections including but not limited to inserts, knobs, holes, recesses, protrusions, glue, screws, nails, and/or any other type of attachment.

However, any other size, shape, design or configuration is hereby contemplated for use.

Side Portion 84

In the arrangement shown, as one example, bracket 80 includes a side portion 84. The side portion 84 is formed of any suitable size, shape, or design. In the arrangement shown, as one example, side portion 84 is generally flat and extends at an angle in direct relation to an end wall 50 of the main body 20. Further, side portion 84 generally extends in parallel spaced relation to an end wall 50 of main body 20.

In the arrangement shown, as one example, side portion 84 is comprised of a first aperture 94 and a second aperture 96, however any number of apertures may be used in connection with the side portion 84 of bracket 80. In the arrangement shown, as one example, the first aperture 94 and second aperture 96 of the side portion 84 may be of any size, shape, or design to engage and accommodate the reliefs 38 located in the lower surface 30 of main body 20. The first aperture 94 and second aperture 96 engage reliefs 38 to allow bracket 80 to be securely connected to main body 20.

However, any other size, shape, design or configuration is hereby contemplated for use.

### Lower Portion 86:

In the arrangement shown, as one example, bracket 80 includes lower portion 86. Lower portion 86 is formed of any suitable size, shape, or design. In the arrangement shown, as one example, lower portion 86 is generally flat and extends across a surface that system 10 may be attached to. Further, lower portion 86 generally extends in parallel spaced relation to such surface. In the arrangement shown, as one example, lower portion 86 is comprised of one or more slots 88.

In the arrangement shown, as one example, one or more slots 88 in lower portion 86 may be of any size, shape, or design to allow bracket 80 to be attached to a surface. One or more slots 88 allow bracket 80 to be attached to a surface using bolts, screws, nails, a strap, or any other attachment means which may be directed through the one or more slots 88.

In the arrangement shown, as one example, bracket 80 is attached to a surface when an attachment means extends through the one or more slots 88 in lower portion 86. However, embodiments are not so limited. Rather, it is contemplated that bracket 80 may be attached to a surface using various different types of rigid or flexible connections including but not limited to glue, nails, screws, inserts, knobs, holes, recesses, protrusions, and/or any other type of attachment.

However, any other size, shape, design or configuration is hereby contemplated for use.

### In Operation:

In the arrangement shown, as one example, system 10 is formed of components that can be attached to various surfaces to facilitate simple transportation while providing a durable surface for cleaning shoes. In one or more arrangements, as one example, the main body 20 of system 10 has the shape of a rectangle or square. These dimensions allow system 10 to fit easily on the running board of a truck or even within the cab of a truck. However, the embodiments are not so limited. Rather, it is contemplated that components of system 10 may be scaled up or down to any desired size. Further, in this example arrangement, system 10 may also be easily stored when not in use.

To assemble system 10, main body 20 is placed on a surface in any location where a user may want to clean their shoes. The lower surface 30 of the main body 20 is placed in direct contact with a surface. After the main body 20 is placed, a plurality of brushes 22 extend up and away from the upper surface 28 of the main body 20 of system 10.

In one embodiment, with the main body 20 placed on a surface, a bolt, screw, nail, or any other type of fastener may be directed through one or more openings 46. In this embodiment, a fastener is directed through one or openings 46 in upper surface 28, through lower surface 30, and into the surface. The fastener may be tightened until system 10 fits snugly to a surface.

Alternatively, with the main body 20 placed on a surface, one or more attachment members 24 may be fastened. In one embodiment, system 10 may be attached using the sidewalls 32 of main body 20 and a strap 54. In this embodiment, the second end 58 of strap 54 is directed through a buckle 60 which facilitates attachment of strap 54 to itself. Strap 54 is then tightened or pulled until system 10 fits snugly to a surface. In an alternative embodiment, system 10 may be attached using the sidewalls 32 of main body 20 and a connection assembly 62. In this embodiment, one or more attachment members 24 may be in the form of a connection assembly 62. In this example, a first tether 74 and a second tether 76 extend from one or more inserts 26 in the sidewalls 32 of the main body 20. The ends of the first tether 74 and second tether 76 include one or more hook and loop fasteners 64 to facilitate attachment of the first tether 74 and the second tether 76 to themselves. The hook and loop fasteners 64 may be tightened or loosened to allow system 10 to conform to various surfaces. In an alternative embodiment, a bolt, screw, nail, or any other type of fastener used in connection with a bracket 80 may be used to facilitate attachment of the end walls 50 of system 10 to a surface. In this embodiment, a fastener is directed through one or more slots 88 in lower portion 86 of bracket 80 and into the surface upon which system 10 is placed. The fastener may be tightened until system 10 fits snugly to the surface.

The reliefs 38 of the lower surface 30 of the main body 20 allow system 10 to bend or conform around any surface. To facilitate bending of reliefs 38, one or more attachment members 24 may be tightened until system 10 conforms to the shape of the surface it is placed on.

With components of system 10 in these positions, the components are interconnected and are further secured in place when a user applies pressure with a shoe to the plurality of brushes 22 extending from the upper surface 28 of the main body 20. In this manner, an interconnected shoe cleaning system 10 is formed that can attach and conform to various surfaces to facilitate simple transportation while providing a durable surface for cleaning shoes.

From the above discussion it will be appreciated that the disclosed system presented herein improves upon the state of the art. Specifically, in one or more arrangements, an improved shoe cleaning system is provided: that has the necessary strength, rigidity, and durability, while also remaining affordable and relatively lightweight; that is formed of components; that is convenient to transport and store; that can effectively remove debris from shoes; that is rigid; that minimizes displacement under strong user pressure; that is relatively easy to manufacture; that is easy to use; that is relatively lightweight; that is easy to move; has a robust design; that is durable; that has a long useful life; that is not easily susceptible to wear and tear; that is high quality; that is relatively inexpensive; that is easy to transport; that protects supporting surfaces from damage caused by users cleaning their shoes; and/or that has the ability to attach to and conform to various surfaces, among countless other advantages and improvements.

It will be appreciated by those skilled in the art that other various modifications could be made to the embodiments without parting from the spirit and scope of this disclosure. All such modifications and changes fall within the scope of the claims and are intended to be covered thereby.

What is claimed:

1. A shoe cleaning system, comprising:
a main body;
the main body having an upper surface;
the main body having a lower surface;
the main body having opposing sidewalls;
the main body having opposing end walls;
the main body having a plurality of brushes;
wherein the plurality of brushes extend out of the upper surface;
the main body having a plurality of reliefs;
wherein the plurality of reliefs are positioned in the lower surface;
a first opening;
wherein the first opening extends through at least a portion of the main body; and
wherein the first opening facilitates attachment of the main body to a vehicle.

2. The system of claim 1, wherein the sidewalls extend outward at an angle as they extend from the upper surface to the lower surface.

3. The system of claim 1, wherein the end walls extend outward at an angle as they extend from the upper surface to the lower surface.

4. The system of claim 1, wherein the first opening is positioned in the upper surface of the main body and extends generally vertically through the main body from the upper surface to the lower surface.

5. The system of claim 1, wherein the first opening is positioned in a sidewall of the main body and extends generally horizontally through at least a portion of the main body.

6. The system of claim 1, further comprising:
a first attachment member;
wherein the first attachment member extends through at least a portion of the first opening; and
wherein the first attachment member is configured and arranged to attach the main body to the vehicle.

7. The system of claim 1, further comprising:
a second opening;
wherein the second opening extends through at least a portion of the main body;
a second attachment member;
wherein the second attachment member extends through at least a portion of the second opening; and
wherein the second attachment member is configured and arranged to attach the main body to the vehicle.

8. The system of claim 1, further comprising the first attachment member having a first buckle, wherein the first buckle is configured to facilitate attachment of the system to the vehicle.

9. The system of claim 1, further comprising the first attachment member having a first connection assembly, wherein the first connection assembly is configured to facilitate attachment of the system to the vehicle.

10. The system of claim 1, further comprising the first attachment member having a first connection assembly, wherein the first connection assembly is configured to facilitate attachment of the system to the vehicle, and wherein the first connection assembly includes a hook and loop system.

11. The system of claim 1, further comprising the first attachment member having a first bracket, wherein the first bracket is configured to facilitate attachment of the system to the vehicle.

12. The system of claim 1, wherein the plurality of brushes are generally circular in shape when viewed from above.

13. The system of claim 1, wherein the plurality of brushes are positioned in a pattern across the upper surface of the main body.

14. The system of claim 1, further comprising a first insert; wherein the first insert is positioned within the first opening; wherein the first insert is formed of a material that is harder than the material the main body is formed of.

15. The system of claim 1, wherein the plurality of reliefs taper inward as they extend upward from the lower surface of the main body such that the plurality of reliefs are wider at the lower surface than they are at an upper end.

16. The system of claim 1, wherein the plurality of reliefs extend across the lower surface of the main body in parallel spaced relation to one another.

17. The system of claim 1, wherein when the main body is tightened to the vehicle, the plurality of reliefs are configured and arranged to facilitate the main body to flex to accommodate that shape of the portion of the vehicle the main body is attached to.

18. A shoe cleaning system, comprising:
a main body;
the main body having an upper surface;
the main body having a lower surface;
the main body having opposing sidewalls;
the main body having opposing end walls;
the main body having a plurality of brushes;
wherein the plurality of brushes extend out of the upper surface;
the main body having a plurality of reliefs;
wherein the plurality of reliefs are positioned in the lower surface;
a first opening;
wherein the first opening extends through at least a portion of the main body;
a first attachment member;
wherein the first attachment member extends through at least a portion of the first opening;
wherein the first attachment member is configured and arranged to attach the main body to a vehicle.

19. The system of claim 18, wherein the first opening is positioned in the upper surface of the main body and extends generally vertically through the main body from the upper surface to the lower surface.

20. The system of claim 18, wherein the first opening is positioned in a sidewall of the main body and extends generally horizontally through at least a portion of the main body.

21. The system of claim 18, further comprising:
a second opening;
wherein the second opening extends through at least a portion of the main body;
a second attachment member;
wherein the second attachment member extends through at least a portion of the second opening;
wherein the second attachment member is configured and arranged to attach the main body to the vehicle.

22. The system of claim 18, further comprising the first attachment member having a first buckle, wherein the first buckle is configured to facilitate attachment of the system to the vehicle.

23. The system of claim 18, further comprising the first attachment member having a first connection assembly, wherein the first connection assembly is configured to facilitate attachment of the system to the vehicle.

24. The system of claim 18, further comprising the first attachment member having a first connection assembly, wherein the first connection assembly is configured to facilitate attachment of the system to the vehicle, and wherein the first connection assembly includes a hook and loop system.

25. The system of claim 18, further comprising the first attachment member having a first bracket, wherein the first bracket is configured to facilitate attachment of the system to the vehicle.

26. The system of claim 18, wherein the plurality reliefs taper inward as they extend upward from the lower surface of the main body.

27. The system of claim 18, wherein the plurality of reliefs extend across the lower surface of the main body in parallel spaced relation to one another.

28. The system of claim 18, wherein when the main body is tightened to a vehicle, the plurality of reliefs are configured and arranged to facilitate the main body to flex to accommodate that shape of the portion of the vehicle the main body is attached to.

29. A shoe cleaning system, comprising:
a main body;
the main body having an upper surface;
the main body having a lower surface;
the main body having opposing sidewalls;
the main body having opposing end walls;
the main body having a plurality of brushes;
wherein the plurality of brushes extend out of the upper surface;
the main body having a plurality of reliefs;
wherein the plurality of reliefs are positioned in the lower surface;
a first opening;
wherein the first opening extends through at least a portion of the main body;
a first attachment member;
wherein the first attachment member extends through at least a portion of the first opening;
wherein the first attachment member is configured and arranged to attach the main body to a vehicle;
a second opening;
wherein the second opening extends through at least a portion of the main body;
a second attachment member;
wherein the second attachment member extends through at least a portion of the second opening; and
wherein the second attachment member is configured and arranged to attach the main body to the vehicle.
